(19) United States
(12) Patent Application Publication
(10) Pub. No.: US 2006/0004623 A1
(43) Pub. Date: Jan. 5, 2006

(54) System and method for online professional services networks

(76) Inventor: Raja V. Jasti, Cupertino, CA (US)

Correspondence Address: Zilka-Kotab, PC, P.O. BOX 721120, SAN JOSE, CA, 95172-1120, US

(21) Appl. No.: 10/884,532

(22) Filed: Jul. 2, 2004

(51) Int. Cl. G06Q 90/00

(52) U.S. Cl. 705/10

(57) ABSTRACT

Online professional services networks that create and provide access to professional service provider databases where the professionals are linked to others based on their referral relationships. The networks allow users, e.g., network members and other consumers (e.g. patients, clients) to search/identify, evaluate and select professionals based on their trusted relations and recommendations, as well as to perform various other tasks online such as negotiate service terms as well as request and submit payment.

### FIELD OF THE INVENTION

The present invention relates to online professional services networks, and more particularly, this invention relates to professional services networks that facilitate referrals, contracting, and scheduling.

### BACKGROUND OF THE INVENTION

Online social networks are gaining rapid adoption in both consumer and business applications. Social networking software and services attempt to capture the network of relationships developed in the real world and help take better advantage of them in achieving social and professional objectives. For example, they are being used for such applications as finding friends, jobs and sales contacts.

Portals and search companies such as GOOGLE, YAHOO and MICROSOFT (MSN) have announced social networking efforts that will incorporate relationship information to improve the quality of the people search and personalization features. However, such social networking systems have a horizontal and broad focus, and as such, tend to provide services that are generic and impersonal. What has heretofore been lacking is application and extension of social networking concepts to vertical industries where relationship networks play a crucial role in how business is conducted in the real world.

One area where online social networks can deliver great value is in their application to professional communities where relationships and networking are essential for business success and survival, and informal, word of mouth referrals are most common. Specialists like doctors, lawyers and therapists develop their businesses by cultivating relationships with others in the profession and by making their services known to potential consumers of their services. They depend considerably on the ecosystem of networks consisting of others in the profession to find new business opportunities, stay in touch with the activities in their professional community, client referrals, etc.

Existing social networking companies focusing on professional networking merely provide directory listings. However these listings are just yellow pages with some search capabilities. They do not offer any decision support capabilities to help in the selection process.

Properly structured, online referral networks can provide a powerful and valuable resource for these professional communities to grow and leverage not only their direct connections but also their extended network, i.e. the connections of their direct connections. Besides making the networking process easy and more efficient, online referral networks can provide benefits that are far beyond what existing networks can provide.

### SUMMARY OF THE INVENTION

The present invention provides online professional services networks that create and provide access to professional service provider databases where the professionals are linked to others based on their referral relationships. The networks allow users, e.g., network members and other consumers (e.g. patients, clients) to search/identify, evaluate and select professionals based on their trusted relations and recommendations, as well as to perform various other tasks online. The networks are particularly adapted for professionals in the healthcare and legal services industries.

In general, the online referral networks for healthcare and legal professionals provide the following functionality. They allow members to join the network, and create and manage professional profiles. They allow members to create, grow and manage their relationship networks. They allow members to communicate and share information with others in the network, as well as write recommendations for members they trust. They allow members to search, qualify and refer qualified members to refer their clients. They offer to find a service provider to the consumer public and allow them to make recommendations.

The network can also facilitate negotiation of service terms that allows the user and service provider to negotiate terms such as costs, timing, payment schedules, etc. The network also allows the user to request proposals and cost estimates.

The network also provides features for facilitating payment for professional services.

As the network grows and evolves, its functionality can be expanded to provide additional value added services that complement the referral related processes. Such value added services include negotiation and finalization of (commitment to) terms and contracts, appointment scheduling, billing and payment functions, and client record management.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a graphical depiction of a member profile screen of an online professional services network system.

FIG. 2 is a graphical depiction of a profile screen viewable by others.

FIG. 3 is a graphical depiction of a member recommendation screen.

FIG. 4 is a graphical depiction of a member network screen.

FIG. 5 is a graphical depiction of a member connections screen.

FIG. 6 is a graphical depiction of a member invite screen.

FIG. 7 is a graphical depiction of a member contacts screen.

FIG. 8 is a graphical depiction of a new contacts screen.

FIG. 9 is a graphical depiction of a search screen.

FIG. 10 is a graphical depiction of a member activities screen.

FIG. 11 is a graphical depiction of an information request screen.

FIG. 12 is a graphical depiction of a client referral screen.

FIG. 13 is a graphical depiction of a referral reply screen.

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

The present invention provides online professional services network systems that create and provide access to professional service provider databases where the professionals are linked to others based on their referral relationships. The networks allow users, e.g., network members and other consumers (e.g. patients, clients) to search/identify, evaluate and select professionals based on their trusted relations and recommendations, as well as to perform various other tasks online. The networks are particularly adapted for professionals in the healthcare and legal services industries.

Referrals are one of the common ways people select healthcare and legal service providers. The online referral network of the present invention captures the word of mouth referral process in the real world and brings added efficiencies to it. This process involves sharing of certain types of information among the network members and the end users. As will soon become apparent, the invention makes it possible to automate the processes of selection, negotiation and scheduling of healthcare providers using a referral network. This saves time and effort for patients/clients and helps them find the best suited providers. Further, providers are able to market their services more effectively.

An online professional services network system according to a preferred embodiment is implemented in a network environment such as the Internet, an intranet, wireless network, combinations thereof, etc. The online professional services network system can include one or more network servers and databases that host and run the software, hardware, and data that provide the functionality described herein. Users connect to the network server(s) via the Internet or other network using computing devices including, but not limited to, personal computers (PCs), personal digital assistants (PDAs), wireless telephones, etc. The online professional services network system preferably allows users to communicate with the system via standard web browsers such as MICROSOFT Internet Explorer, though custom interfaces can also be provided. One skilled in the art will understand the software and hardware requirements necessary to provide the functionality of the present invention.

The following description will describe one preferred embodiment of an online professional services network system for healthcare professionals such as doctors, specialists, psychologists, therapists, etc. The online professional services network system includes a group of members each having some connection to each other, albeit through another member. A member is someone registered with the system. Each member is preferably invited to join the network by an existing member, as will be described in more detail below. The system can also include information about non-members, though the information may be less comprehensive than that available for members.

A user accessing the system enters the URL address of the system home page in the address field of a network browser to access a home page. The user then enters login information, such as login ID and password, to access the system functionality.

If the user is a member, the user is preferably granted more access to information as well as can be allowed to provide recommendations and feedback, as well as create connections with other members. If the user is a non-member, the information available to the user is preferably limited to browsing, and possibly providing feedback. If desired, membership can be offered to consumers of services (e.g., clients) such as healthcare patients and legal clients.

For the present discussion, assume that a member is a healthcare professional that has logged in to the system.

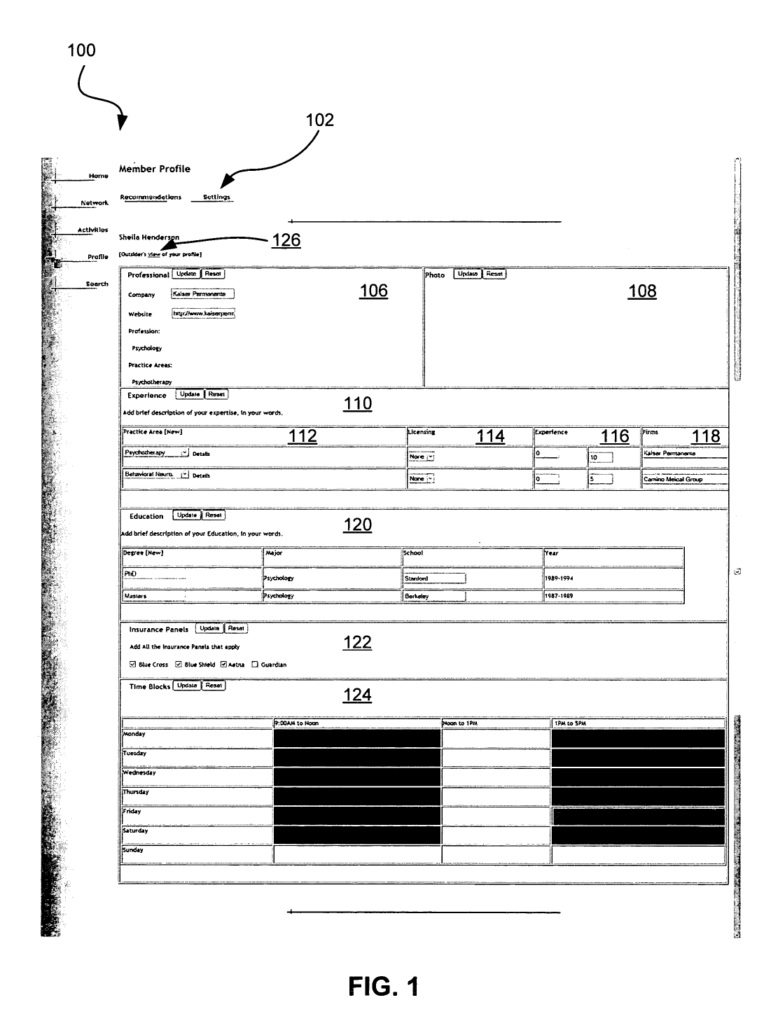

FIG. 1 shows a member profile page 100, from which the member can manage his or her personal and professional information, some or all of which may be accessible to others via the system. By selecting the Settings link 102, the member can dictate which information is provided only to other members, and which is viewable by non-members, e.g., patients and others. The member can also indicate whether other users can contact the member by phone, email, etc.

The profile page 100 has several fields and frames for receiving member information. The professional frame 106 receives employment and skills information about the member. The picture frame 108 receives a picture of the member. The experience frame 110 receives a description of the member's professional experience. The practice area subframe 112 receives the providers main practice areas, preferably via a drop down menu. The licensing subframe 114 indicates whether the member is licensed in a particular jurisdiction, to perform particular tasks, etc. This allows a referring party to see whether the member is certified, is compliant with state and/or federal regulations, etc. The experience subframe 116 indicates the number of months and/or years of experience the provider has. The firms subframe 118 indicates where the member is/was working. The education frame 120 receives the member's educational information.

The insurance panel frame 122 allows the member to indicate which types of insurance the provider accepts, whether the member is a participating provider, etc. In the health care industry this information is referred to as insurance panels, which is a critical element in how the service provider gets paid for the services provided by them. This is also a critical element for the clients in selecting the service provider. This insurance panel information may contain elements including, but not limited to, the insurance provider name, plan options, co-payment information, coverage information, network type such as HMO, PPO etc. But this concept is not just limited to the health care industry but may be extended in general to third party billing and payment provider systems.

The time blocks frame 124 allows the member to segment their weekly calendar into time blocks that they allocate for performing certain types of tasks. A physician member may indicate when he or she is typically available for consultation, surgery, meeting with new patients/clients, providing specialized services, etc., preferably on a recurring basis. For example, the physician can indicate that he or she will see new patients on Mondays from 9-12, perform surgeries on Tuesdays from 1-5, be out of the office on Friday from 12-5, etc. Additionally, the time blocks frame 124 can indicate the member's current schedule so that a user can see what the provider's availability is on specific dates.

This time block feature builds on the concept that professionals such as physicians, lawyers, therapists, etc. use to organize their calendars in time blocks for various types of activities to increase their efficiency by minimizing the time fragmentation. In most cases this type of time block information is more useful than detailed calendar information for sharing with other professional and clients to schedule visits. It should be noted that the time block feature is not limited to sharing time blocks information but also includes sharing detailed calendar information when applicable. Even though weekly time blocks are more common, the time block feature can be used for other schedules such as bi-weekly or monthly time blocks.

The time block feature provides a criterion that can be used by other members to select a provider when making referrals. For example, wherein attempting to refer a patient, the referring member can find a member with a time block that works best for the patient. Scheduling is important, because each referral has a first meeting, and the referring party wants to make sure that the accepting provider can/will meet the patient.

The time block feature also allows a patient to choose a provider based on the best time for the patient. The network further allows users to schedule service visits. If the time block information indicates the provider's availability on specific dates, the user can request specific open time slots. The online referral network can provide a means of communication between the client and service professional to negotiate and schedule a time that is mutually convenient. These communication channels may include, but not limited to email, phone, instant messaging, web conferencing, paging, wireless alerts, faxing, etc.

The member can also perform various other activities, such as enter contact information, change login and password information, etc.

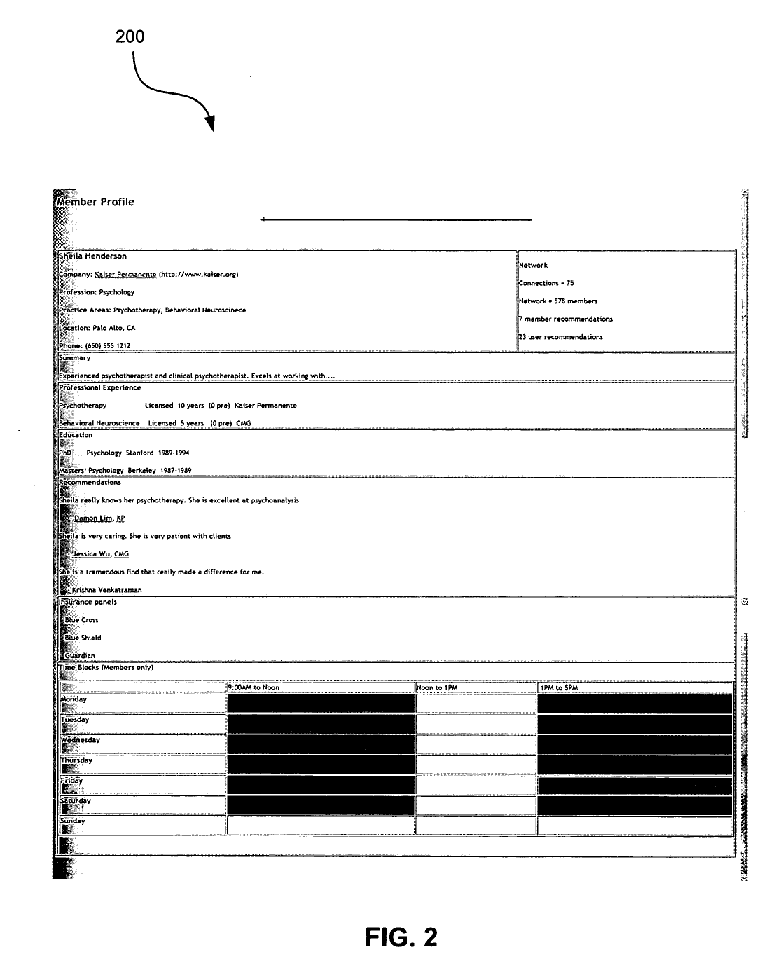

The member can view a page of the information viewable by others by selecting the link 126 to the “outsider's view of your profile.” FIG. 2 shows the page 200 of profile information viewable to other members and/or non-members.

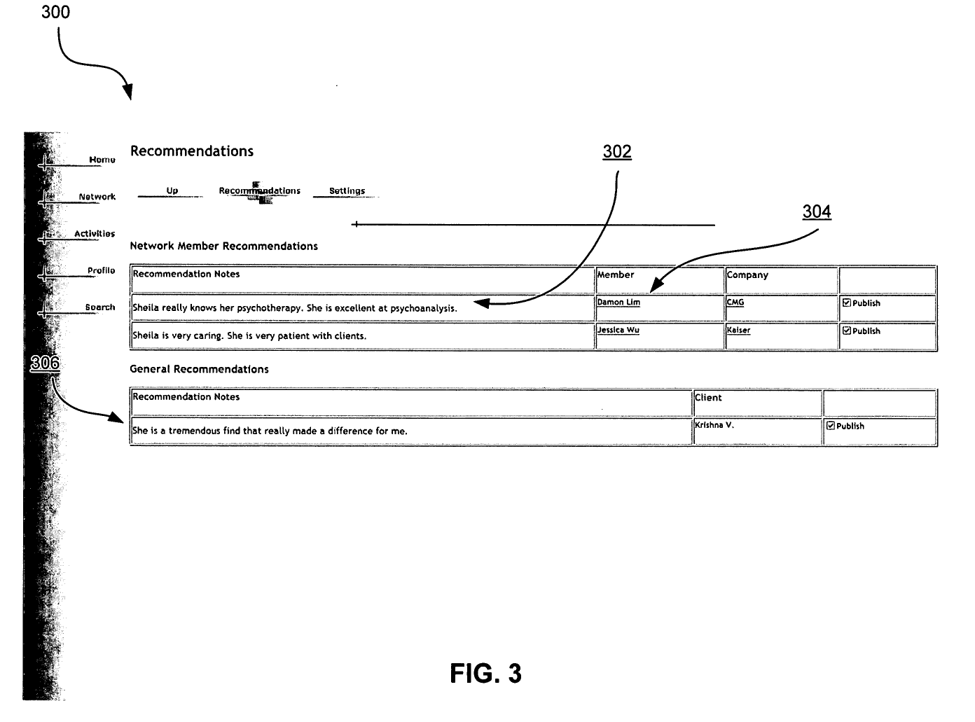

A particularly important feature of the system is that it allows members to write recommendations for other members. By providing recommendations, the system provides qualified leads to users searching for a member provider. FIG. 3 depicts a member recommendations screen 300 which displays recommendations 302 about the member written by other members. So that the reader can investigate the veracity of the recommendation's author, a link 304 to the recommending member is provided to permit a user to see details about who recommended the particular provider. Also displayed are general recommendations 306 from parties who are not members.

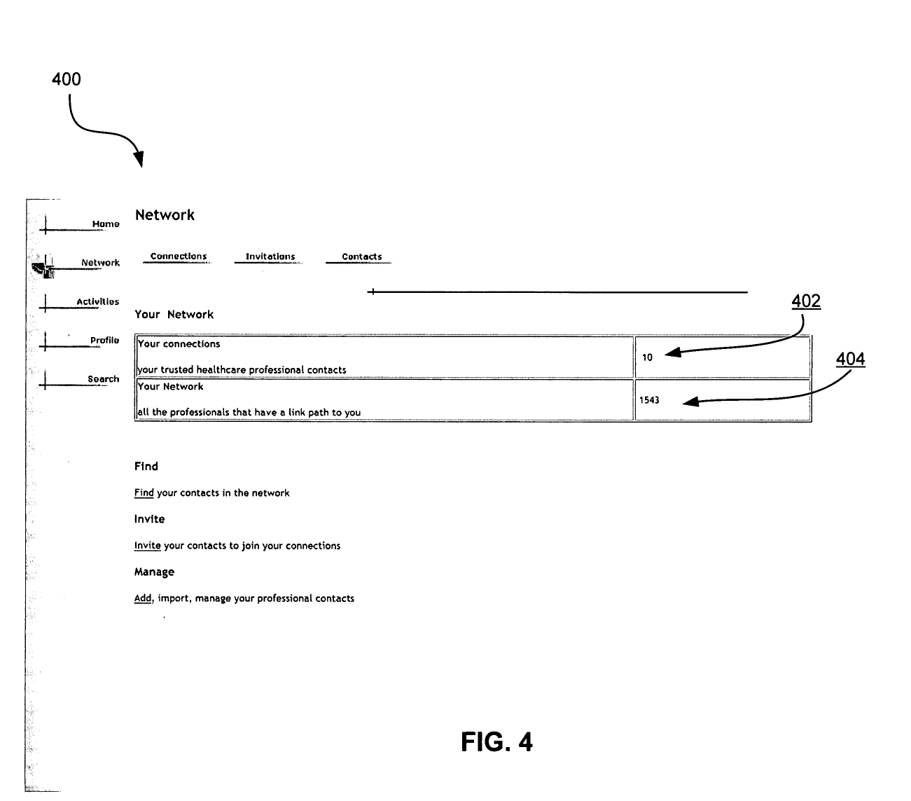

FIG. 4 illustrates a member network page 400, which shows the number of connections 402 and the number of parties 404 in the particular member's network.

Parties are connected if there is a direct connection between the parties. This typically means that the parties know each other and have had dealings in the past. Parties are in the member's network if, by linking through connections of connections, a party using the network can ultimately link to the member

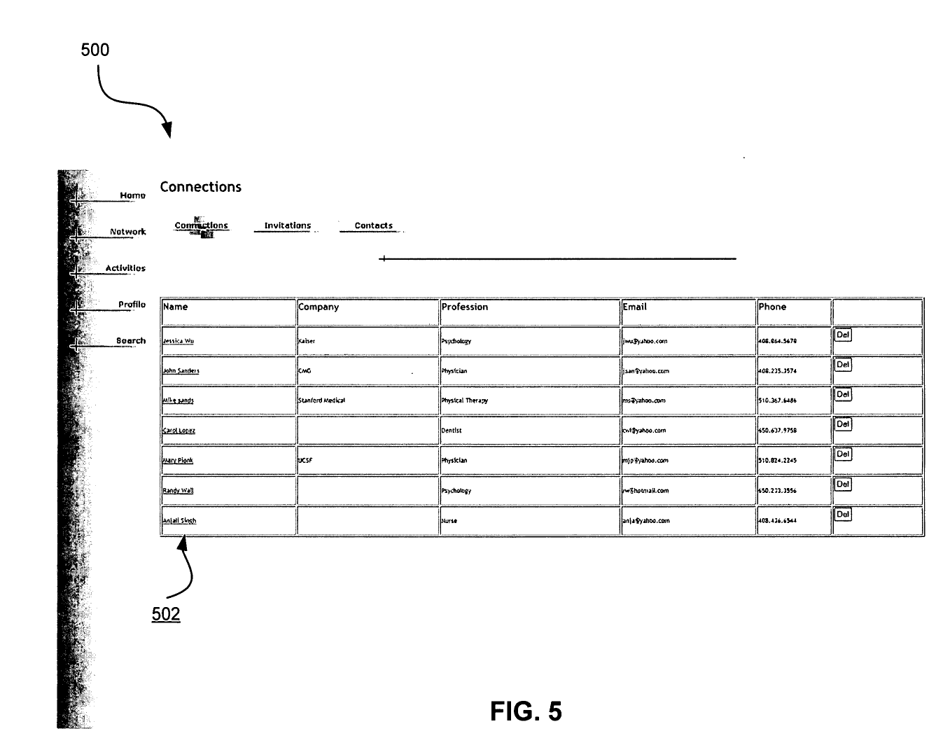

FIG. 5 illustrates a member connections page 500 accessed by selecting the Connections link 406 on the member network page 400. The member connections page 500 lists all members 502 connected to the member. Illustrative members connected to a provider can include one or more of the inviting party, parties who have referred patients to the provider, parties who have written commentary (e.g., recommendations) about the provider, parties invited and consenting to be connected to the member, etc. Again, each of the members 502 is linked to his or her profile page.

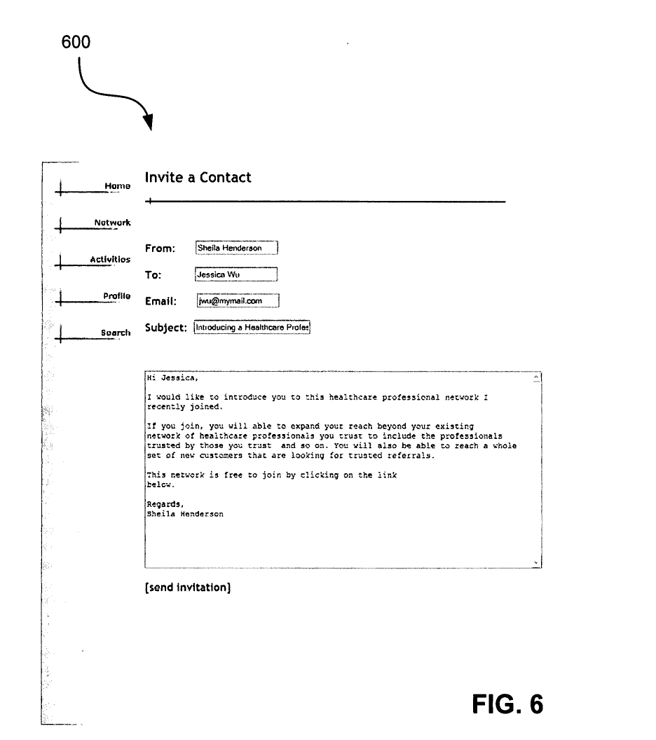

FIG. 6 illustrates a member invite page 600. This page 600 allows an existing member to invite other service providers to join the system, and consequently, his or her network. Preferably, an inter-system message and/or an email is sent to a provider with an invitation to join the system. The message can be pre-generated. Preferably, only existing member can invite others to join the network, though it may be permissible to allow new users to join without a prior connection. As an option, the inviter may be required to affirm that he or she personally knows the invitee.

The cost to join the system can be free, or a fee can be charged to become a member. Also, a tiered service structure can be provided, where advanced features and connectivity is provided to members paying more.

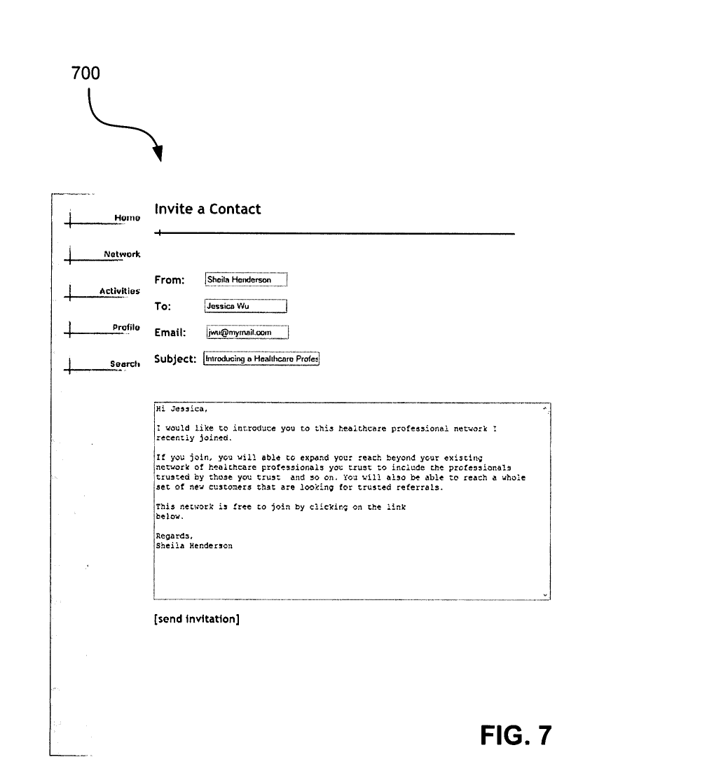

FIG. 7 illustrates a member contacts screen 700 where a member can enter contacts of other professionals and colleagues that have not been added to the member's connections. When a contact is entered, the member can see who is already a member, can keep track of their membership status and when they join, and can invite them to become part of member's network over time.

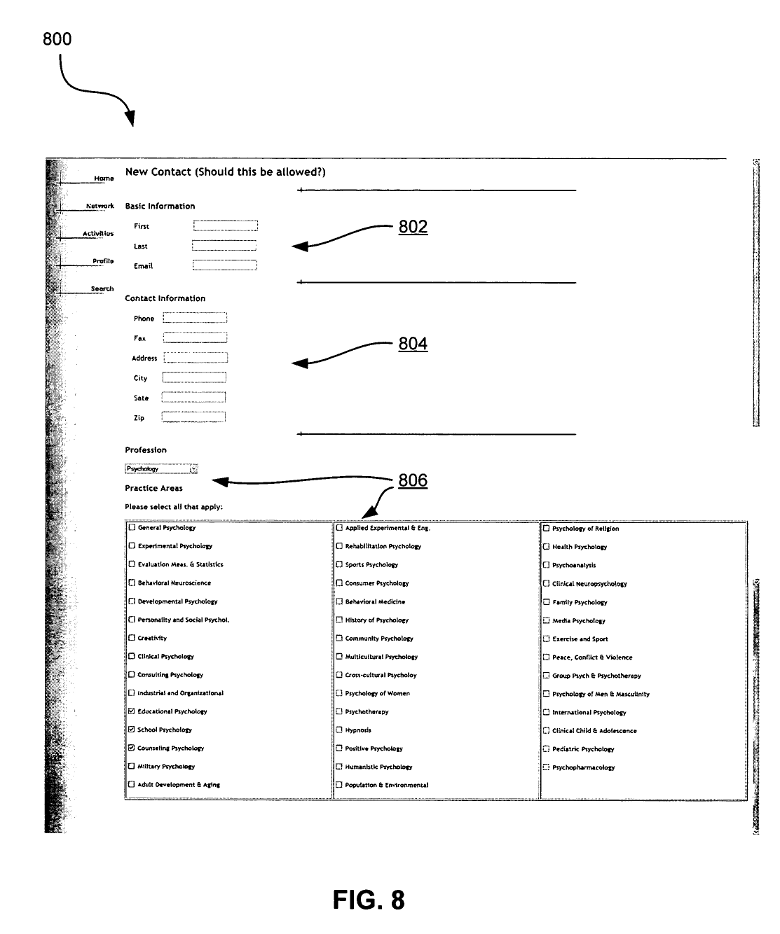

Additional features provided by the member contacts screen 700 include the ability to import contacts from an outside program such as MICROSOFT Outlook, upload a contacts file, and enter a contact manually. FIG. 8 illustrates a new contact page 800 where the member can enter basic information 802, contact information 804, and professional information 806 manually. Note that a similar screen can be provided for amending contact information.

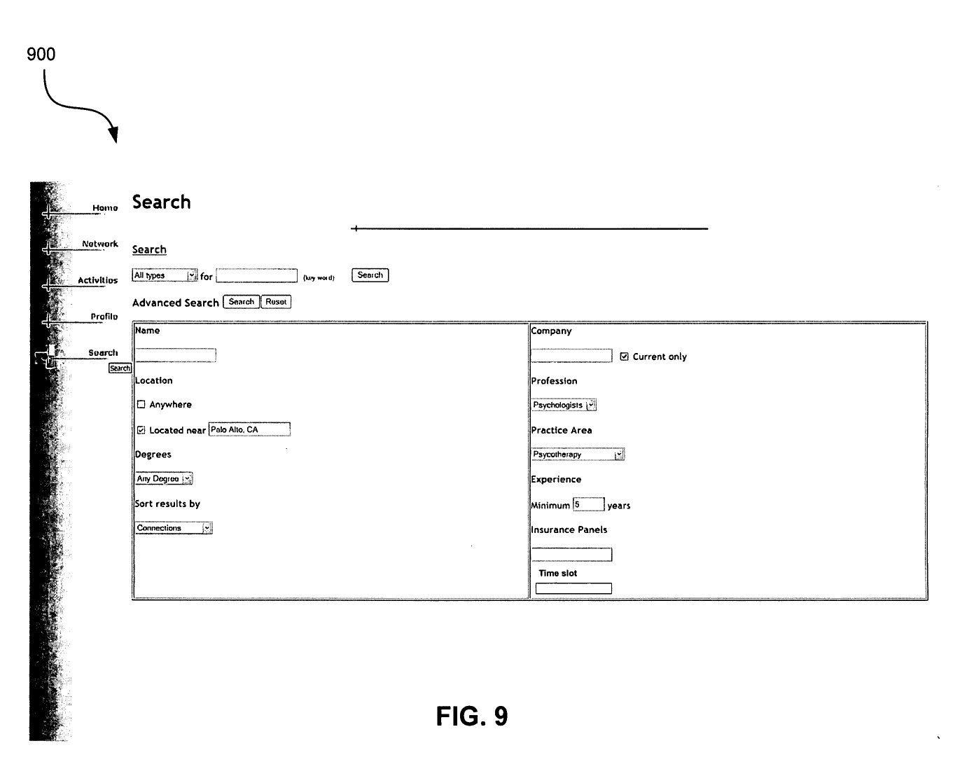

FIG. 9 shows a search page 900 which helps users to find other members. For example, if a user wants to find a particular type of provider, the user can search by location, level of education, current employer, profession, practice area, experience, insurance panel information, and time slot availability, etc. preferably with the aid of drop down fields. Searches can be sorted by and/or limited to members within a particular provider's network or connection list. This allows a member to make a referral to someone who is trusted by another member that has some type of connection to the referring member. Upon performing the search, the system provides a list of members that match the requirements, with a link to the profile of each member.

The system also provides communications features. FIG. 10 shows a member activities page 1000 where members can read and send emails to other members. The online referral network can provide a means of communication between the client and service professional to perform tasks such as request information, negotiate service contracts, schedule meetings, refer other clients or service providers etc. These communication channels may include, but are not limited to email, phone, instant messaging, web conferencing, wireless alerts, paging, faxing, etc.

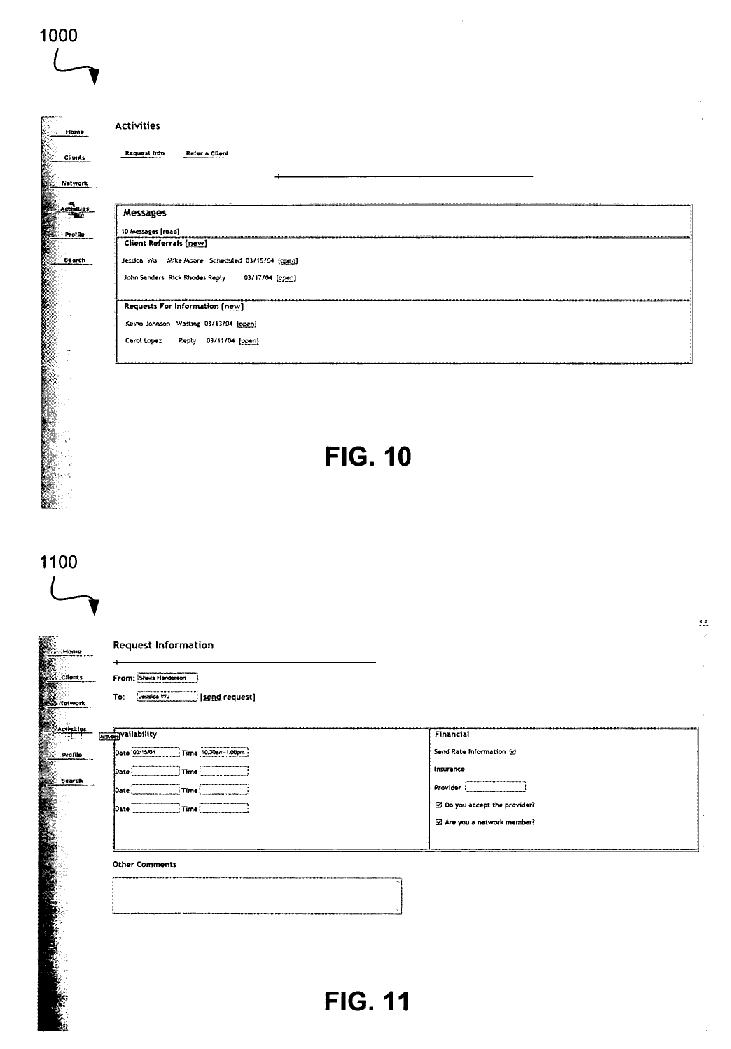

FIG. 11 shows an information request page 1100 which allows the user to request information from a member prior to making referral. Examples of such information requests include, but are not limited to, availability, insurance panels or other third party billing and payment service providers, rate information, client lists for verifying any potential conflicts of interest, etc.

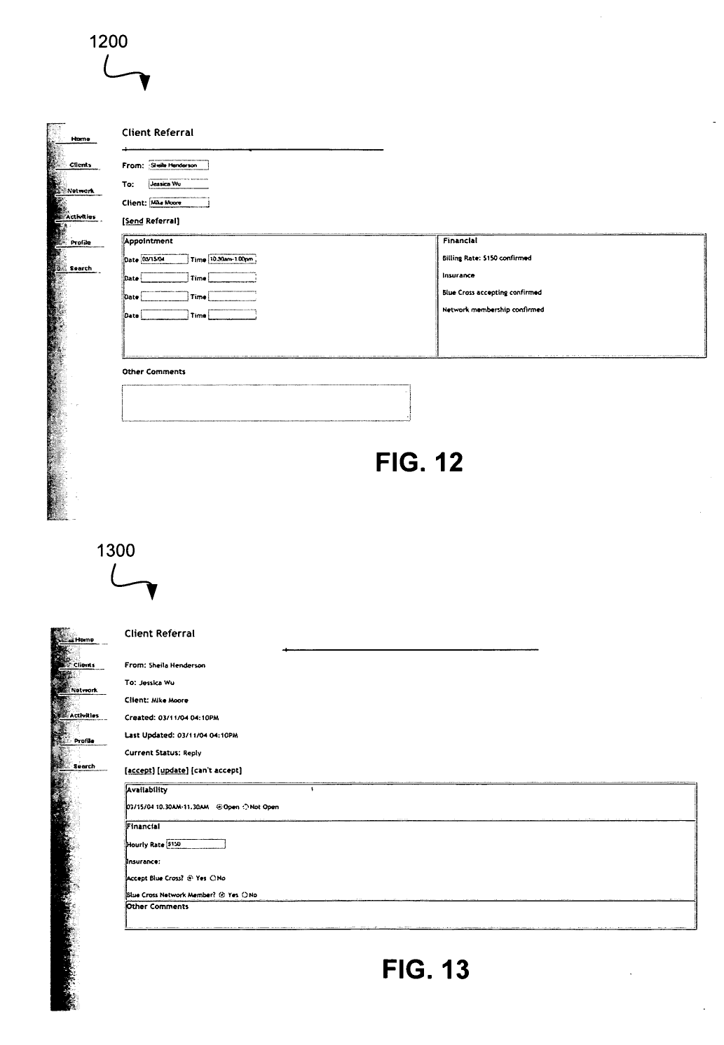

FIG. 12 is a client referral screen 1200 which allows a user to send an email to a member, referring a client to the member.

FIG. 13 is a referral reply screen 1300 that allows a member to accept or reject a referral.

Another optional screen (not shown) is a client list. Some or all of client list can be shown to other providers and potentially to clients, as long as privacy requirements are satisfied. Preferably, the network enforces compliance with state and federal privacy requirements for sharing of client (e.g. patient) information. As an example, if a client is looking for a patent lawyer, then he may wish to see a client list to ensure there are no potential conflicts of interest that may currently exist or arise in the future.

Another optional screen (not shown) may enable the referring professional (e.g. physicians) to request client approval to release or share certain information with the other professionals to whom he or she may be referring the client. The system can require the patient to provide online approval to share personal information, for the protection of the referring party. Again, preferably the network enforces compliance with state and federal privacy requirements and laws for sharing of client (e.g. patient) information.

As the network grows and evolves, its functionality can be expanded to provide additional value added services that complement the referral related processes. Such value added services include negotiation and finalization of (commitment to) terms and contracts, appointment scheduling, billing and payment functions, and client record management.

The network also allows users to negotiate service contracts and terms. This may involve client and the service provider negotiating fees and costs and/or going through a formal request for quote (RFQ) or request for proposal (RFP) process. This may also involve the service provider sharing their standard contract documents with the client and negotiating the terms and signing the documents electronically or otherwise.

A user interface screen or screens can be provided that allows the user to fill in a desired fee including hourly billing rates and flat fees for services, fees for materials and use or equipment, etc. and submit that information to a selected service provider. The interface can provide predefined fields or text input fields for the user to fill in, such as proposed billing rate, proposed flat fee, proposed cap on costs, proposed cost for materials, proposed schedule or time to complete the services, proposed payment schedule, etc. Preferably, the interface also lists the service provider's typical or preferred fees and costs, which the user can simply accept if acceptable. The interface can also allow input of textual messages. This would be particularly useful where a RFQ or RFP is desired. The user can then input the desired service. Likewise, a referring member can also negotiate on behalf of a client being referred.

The interface can also allow the service provider to respond to the user's inquiry, such as by accepting the user's proposal or offering counter proposals.

Upon reaching an agreement, a screen can display the final terms of the agreement and require the user and the service provider to accept the service terms.

The network also allows users to perform payment transactions. This may involve enabling the service provider to bill (send invoice to) the client or a third party such as an insurance provider or party responsible for the client directly at the appropriate time according to their service contract agreement. This may also enable the client or the insurance provider to pay the service professionals electronically (such as by electronic funds transfer, credit card transaction, etc.) or otherwise (e.g., by request for check).

An interface screen or screens can allow the service provider to select the client from a list of client and assemble an invoice for submission to the appropriate party. The network can submit the invoice electronically based on stored contact information for the party (e.g., email address, fax number, etc.), or send to a billing person working with the service provider a request to prepare and mail a paper invoice.

As mentioned above the system provides a method for the network members to obtain client release consent to share the required client information in order to facilitate the above services and transactions. This may involve sharing or sending a release consent form (electronic or otherwise) to the client and obtaining the release consent to enable sharing client information to facilitate the referral or service contract execution. Preferably the network enforces compliance with state and federal privacy requirements for sharing of client (e.g., patient) information.

While the foregoing description was for a system for healthcare providers, one skilled in the art will understand that the system would work equally well for legal professionals. The structure of an online legal professionals network system would have a similar structure, with some variations. For instance, the system would not typically include insurance information, but could include a client list for conflict checking and as a selling point. Scheduling information would be provided to indicate when the lawyer is in the office, in court (e.g., family court on Wednesdays), etc. The attorney's hourly rate can be provided, as well as whether the attorney is amenable to flat fee arrangements, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for facilitating online referrals, comprising the computer implemented steps of:
storing profile information about a plurality of members, each of the members being a professional service provider;
linking at least some of the members to each other based on relationship criteria for creating connections between the members;
allowing a user to view at least a portion of the profile information of a first of the members;
allowing a user to view at least a portion of the profile information of the members connected to the first member; and
allowing a user to refer a patient or client to one of the members.

2. A method as recited in claim 1, further comprising allowing searching of the profile information.

3. A method as recited in claim 2, wherein selectable search parameters for the searching are selected from a group consisting of: location, level of education, current employer, profession, practice area, experience, insurance panel information, and time slot availability.

4. A method as recited in claim 2, wherein the searching is limited to members within a particular member's network or connection list.

5. A method as recited in claim 1, further comprising allowing a user to read a recommendation about one member written by another member.

6. A method as recited in claim 5, further comprising providing a link to profile information about the recommending member.

7. A method as recited in claim 1, wherein only member users can refer a patient or client to one of the members.

8. A method as recited in claim 1, wherein the member profile information includes time block information.

9. A method as recited in claim 8, wherein the time block information indicates a recurring schedule of activities of the member.

10. A method as recited in claim 8, wherein the time block information indicates an actual schedule of activities of the member.

11. A method as recited in claim 10, further comprising allowing a user to request a visit based on the time block information.

12. A method as recited in claim 1, wherein the member profile information includes insurance panel information.

13. A method as recited in claim 1, wherein the member profile information includes information about the associated member's licensing.

14. A method as recited in claim 1, wherein the member profile information includes a list of clients of the member.

15. A method as recited in claim 1, wherein two members are connected if one member invited the other member to become a member.

16. A method as recited in claim 1, wherein two members are connected if one member has written a recommendation about the other member.

17. A method as recited in claim 1, wherein two members are connected if one member has referred a patient or client to the other member.

18. A method as recited in claim 1, further comprising allowing a user to request consent from a client or patient to share information about the client or patient.

19. A method as recited in claim 1, wherein compliance with privacy laws is enforced.

20. A method as recited in claim 1, further comprising allowing a user to negotiate service terms with a member.

21. A method as recited in claim 1, further comprising allowing a user to perform a payment transaction.

22. A method as recited in claim 1, with the proviso that the claim is limited to medical service providers.

23. A method as recited in claim 1, with the proviso that the claim is limited to legal service providers.

24. A method for facilitating online referrals, comprising the computer implemented steps of:
storing profile information about a plurality of members, each of the members being a professional service provider;
linking at least some of the members to each other based on relationship criteria for creating connections between the members;
allowing a user to view at least a portion of the profile information of a first of the members;
allowing a user to view at least a portion of the profile information of the members connected to the first member;
allowing a user to read a recommendation about one member written by another member;
allowing a user to search the profile information; and
allowing a user to refer a patient or client to one of the members.

25. A method as recited in claim 24, wherein selectable search parameters for the searching are selected from a group consisting of: location, level of education, current employer, profession, practice area, experience, insurance panel information, and time slot availability.

26. A method as recited in claim 24, wherein the searching is limited to members within a particular member's network or connection list.

27. A method as recited in claim 24, further comprising providing a link to profile information about the recommending member.

28. A method as recited in claim 24, wherein only member users can refer a patient or client to one of the members.

29. A method as recited in claim 24, wherein the member profile information includes time block information.

30. A method as recited in claim 29, wherein the time block information indicates a recurring schedule of activities of the member.

31. A method as recited in claim 29, wherein the time block information indicates an actual schedule of activities of the member.

32. A method as recited in claim 31, further comprising allowing a user to request a visit based on the time block information.

33. A method as recited in claim 24, wherein the member profile information includes insurance panel information.

34. A method as recited in claim 24, wherein the member profile information includes information about the associated member's licensing.

35. A method as recited in claim 24, wherein the member profile information includes a list of clients of the member.

36. A method as recited in claim 24, wherein two members are connected if one member invited the other member to become a member.

37. A method as recited in claim 24, wherein two members are connected if one member has written a recommendation about the other member.

38. A method as recited in claim 24, wherein two members are connected if one member has referred a patient or client to the other member.

39. A method as recited in claim 24, further comprising allowing a user to request consent from a client or patient to share information about the client or patient.

40. A method as recited in claim 24, wherein compliance with privacy laws is enforced.

41. A method as recited in claim 24, further comprising allowing a user to negotiate service terms with a member.

42. A method as recited in claim 24, further comprising allowing a user to perform a payment transaction.

43. A method as recited in claim 24, with the proviso that the claim is limited to medical service providers.

44. A method as recited in claim 24, with the proviso that the claim is limited to legal service providers.

45. A method for facilitating negotiation of service terms, comprising the computer implemented steps of:
storing profile information about a plurality of professional service providers;
allowing a user to view at least a portion of the profile information of the service providers;
allowing the user to select one of the service providers;
allowing the user to negotiate service terms with the selected service provider; and
allowing the selected service provider to negotiate the service terms with the user.

46. A method as recited in claim 45, wherein the service terms include a proposed cost for services rendered by the service provider.

47. A method as recited in claim 46, wherein the proposed cost for services rendered by the service provider are selected from a group consisting of a time-based cost, a flat fee, a cost for materials, a cost for use of equipment.

48. A method as recited in claim 45, wherein the service terms include a proposed time for completion of services rendered by the service provider.

49. A method as recited in claim 45, wherein the service terms include a proposed payment schedule.

50. A method as recited in claim 45, further comprising displaying standard terms and allowing the user to propose variations to the standard terms.

51. A method as recited in claim 45, further comprising allowing the user to request a proposal for services from the service provider.

52. A method as recited in claim 45, further comprising allowing the user to request a proposed quote from the service provider.

53. A method as recited in claim 45, further comprising displaying a set of negotiated terms and allowing the user and service provider to electronically accept the negotiated terms.

54. A method as recited in claim 45, with the proviso that the claim is limited to medical service providers.

55. A method as recited in claim 45, with the proviso that the claim is limited to legal service providers.

56. A method for facilitating payment for professional services, comprising the computer implemented steps of:
storing information about a plurality of members, each of the members being a professional service provider;
storing information about a party selected from a group consisting of a client of the service provider, a third party responsible for payment for the client, and an insurance company;
allowing the service provider to request payment from the party;
transmitting the request for payment to the party; and
facilitating payment from the party to the service provider.

57. A method as recited in claim 56, wherein facilitating payment includes facilitating an electronic payment from the party to the service provider.

58. A method as recited in claim 57, wherein the electronic payment is an electronic funds transfer.

59. A method as recited in claim 57, wherein the electronic payment is a credit card transaction.

60. A method as recited in claim 56, with the proviso that the claim is limited to medical service providers.

61. A method as recited in claim 56, with the proviso that the claim is limited to legal service providers.

62. A system for facilitating online referrals, comprising:
logic for storing profile information about a plurality of members, each of the members being a professional service provider;
logic for linking at least some of the members to each other based on relationship criteria for creating connections between the members;
logic for allowing a user to view at least a portion of the profile information of a first of the members;
logic for allowing a user to view at least a portion of the profile information of the members connected to the first member; and
logic for allowing a user to refer a patient or client to one of the members.
